(19) United States
(12) Patent Application Publication
(10) Pub. No.: US 2003/0229692 A1
(43) Pub. Date: Dec. 11, 2003

(54) System and method for monitoring data traffic on a network

(76) Inventor: Kiem-Phong Vo, Berkeley Heights, NJ (US)

Correspondence Address: Samuel H. Dworetsky, AT&T CORP., P.O. BOX 4110, Middletown, NJ, 07748-4110, US

(21) Appl. No.: 10/002,277

(22) Filed: Nov. 2, 2001

(51) Int. Cl. G06F 15/173

(52) U.S. Cl. 709/224

(57) ABSTRACT

The present invention provides a network monitoring device that monitors a network in order to gather information on the traffic flow generated by network users over the network. The network monitoring device can subsequently distribute network traffic information to subscribers. As the network traffic information is gathered, the network monitoring device can further analyze the information to discern patterns in the traffic flows. A large network service provider with access to network traffic data from a large population of network end-users and business servers can use the network traffic data to obtain information on various patterns in the network traffic data flow and related business interests in real-time.

### BACKGROUND OF THE INVENTION

1. Field of Invention

The invention relates to a network monitoring device and method for monitoring and distributing network traffic data to terminals of a network.

2. Description of Related Art

Currently, network service providers operate data networks that permit a plurality of network users to communicate with each other. The network users can be roughly divided into two groups: servers and individual users. Generally, the servers are terminals connected with the network that provide a service to their clients, such as selling products or providing information. The individual users are terminals that can be used by private individuals for communicating over the network, such as by e-mail, IP telephony, or video conferencing. A portion of the individual users may also be clients of the servers that use the network to purchase products and services from the servers.

Presently, network service providers are able to collect network traffic data for maintenance and management of their networks. The network traffic data includes information about the use of the network by all the network users connected with the network. The network traffic data is usually acquired over relatively large periods of time, and then the aggregated data is analyzed to determine traffic flow patterns. However, traffic on the network is continually changing. New sites are constantly being added to the network while others are being removed, and new networks are continually linking to existing networks.

### SUMMARY OF THE INVENTION

Accordingly, it is an object of the present invention to provide a network monitoring device that monitors a network in order to gather information on the traffic flow generated by network users over the network. The network monitoring device can subsequently distribute network traffic information to subscribers. As the network traffic information is gathered, the network monitoring device can further analyze the information to discern patterns in the traffic flows. A large network service provider, such as AT&T, with access to network traffic data from a large population of network end users and business servers can use the network traffic data to obtain information on various patterns in the network traffic data flow and related business interests in real-time.

Knowledge about data traffic flow can be very valuable for businesses and/or individuals that have web sites on a network, such as the Internet. Such data traffic flow information can include information on where, when and what sites are being visited along with data indicating with what volume they are being visited. With such information, network users are able to update their sites or change the presence of their sites to correspond to the actions and desires of individual users on the network. By enhancing sites in real-time based on the network traffic information, the network users will be able to target their sites and attract a certain clientele.

For example, by analyzing network traffic data, a focused interest of network users in a type of business, such as the flower business, might be discovered. The network traffic data may indicate that a few flower shops are getting a majority of the marketshare of data traffic related to the flower business. From this information, it may be deduced that these businesses are offering some type of deal to attract clients. Furthermore, competitors may visit the heavily traveled sites to determine why the sites are attracting a large marketshare. The businesses that receive the traffic information may be inclined to offer deals to compete with their business competitors. Therefore, these businesses can gain an edge in the market by knowing how the network traffic is behaving at any moment.

Another example involves the use of advertisements on the network. Usually advertising companies act as a liaison between network sites and companies placing advertisements on those sites. By using the data traffic flow information provided from the analyzed network traffic data, advertising companies can determine which sites are being visited by heavy volumes of network traffic. Additionally, data traffic flow information can indicate a geographical source or origin, such as a county or state, from which the network traffic is being generated. Therefore, advertisements can be strategically and more accurately placed on selected sites of the network. As a result, the click-through rate of those advertisements will increase and the impression the advertisements have on network users will be maximized.

Accordingly, the present invention provides methods and systems for obtaining network traffic information, analyzing the data and displaying the analyzed data. This can be accomplished in real-time to provide businesses and individuals with the advantage of having immediate analyzed network traffic data.

### BRIEF DESCRIPTION OF THE DRAWINGS

The invention is described in detail with regard to the following figures, in which like elements are referred to with like numerals, and in which:

FIG. 1 is an exemplary block diagram of a network traffic monitoring system in accordance with the present invention;

FIG. 2 is an exemplary block diagram of the network monitoring device shown in FIG. 1;

FIG. 3 is an exemplary data structure for storing network traffic information;

FIG. 4 is a graph showing an exemplary network traffic history;

FIG. 5 is an exemplary data structure for storing subscriber information; and

FIG. 6 is a flowchart outlining an exemplary embodiment of the network traffic monitoring system.

### DETAILED DESCRIPTION OF PREFERRED EMBODIMENTS

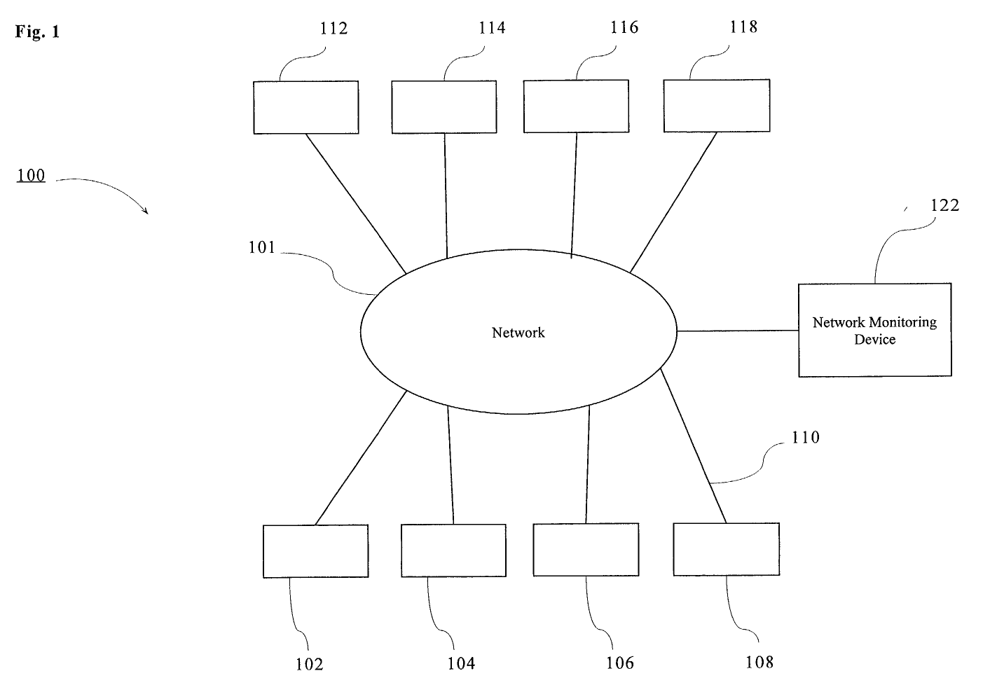

FIG. 1 is an exemplary block diagram of a network traffic monitoring system 100 according to the present invention. As shown in FIG. 1, the system 100 includes terminals 102-108, servers 112-118 and a network monitoring device 122 coupled to the network 101 through a communication link 110.

The terminals 102-108 can be devices of any type that allow for the transmission and/or reception of communication signals and allow a subscriber to connect to and use a network's capacity, features and services, and access content available through the network. For example, the terminals 102-108 may include land-line telephones, smart or computer-assisted televisions, digital set-top audio/video decoders, personal digital video recorders, screen-equipped web phones, voice and video telephone sets, streaming audio and video media players, integrated intelligent digital television receivers, personal computers, workstations, thin-client network computers, radios, personal digital assistants, PCS/cellular wireless voice and Internet phones, mobile satellite receivers, GPS receivers, automated teller machines, or any combination of these. For the purposes of the present disclosure, it will be assumed that terminals 102-108 are personal computers.

The servers 112-118 provide services, such as sales of products, services or information, to terminals 102-108 over the network 101. Each server 112-118 may also independently gather information, for example from other networks or databases, for each terminal 102-108 that uses its services. The servers 112-118 can include one or more computers, databases and the like connected with the network that provide websites, electronic commerce, informational services, search engines, and the like.

The terminals 102-108, servers 112-118 and the network monitoring device 122 are in communication with network 101 through communication links 110. These communication links 110 can be any type of connection, wired or wireless, that allows for transmission of information. Some examples include, but are not limited to, multiple twisted pair cable, digital subscriber lines (DSL), coaxial cable, optical fiber, RF cable modems, over-the-air radio frequency, over-the-air optical wavelength (e.g., infrared), local area networks, wide area networks, intranets, virtual private networks, cable TV, terrestrial broadcast radio or television, satellite transmission, simple direct serial/parallel wired connections, or the like.

The network 101 may be a single network or a plurality of networks of the same or different types. For example, the network 101 may include a local telephone network in connection with a long-distance network (such as an AT&T long-distance telephone network). Further, the network 101 may be a data network or a telecommunications network or video distribution network (e.g., cable, terrestrial, broadcast or satellite) network in connection with a data network. Any combination of telecommunications, video/audio distribution and data networks, whether a global, national, regional, wide-area, local area or in-home network, may be used without departing from the spirit and scope of the present invention. For the purposes of discussion, it will be assumed that the network 101 is a data network.

Network monitoring device 122 monitors the network 101 and gathers network information, such as data traffic being transmitted on the network 101. For example, the network monitor device 122 can monitor communications between the terminals 102-108, between terminals 102-108 and servers 112-118, and between the servers 112-118. The network monitoring device 122 can further monitor communications across the network 101 which only traverse the network 101 (i.e., only travel over the network and are not directed to any of the terminals 102-108 and/or the servers 112-118 connected with the network 101). Further, the network monitoring device 122 can monitor any communication that begins from any of the terminals 102-108 and/or servers 112-118 and are directed to another terminal outside the network 101. In short, the network monitoring device 122 can monitor any communications that are transmitted across the network 101.

To monitor the communications transmitted on network 101, the network monitoring device 122 can examine a header portion of each of the communications, such as an IP header. For example, the IP header can contain an originating and destination terminal address, along with a time that the communication was placed. The information can be extracted from each of the communications and collected in a memory. Once collected in the memory, the network monitoring device 122 can analyze the data to determine any patterns in the aggregate network traffic flow. For example, the network monitoring device 122 can determine if numerous data communications are being transmitted to or from a particular server 112-118 or terminal 102-108 within a period of time. The transmission of numerous communications between the terminals 102-108 and a particular server over a period of time can constitute a traffic pattern. Once a pattern is determined, the network monitoring device 122 may notify any subscribers to which the traffic pattern may be of particular interest.

The network monitoring device 122 may be an independent unit coupled to the network 101 (as shown), or it may be distributed throughout the network 101. For example, the network monitoring device 122 may be resident in the system 100 or equipment located in the various telephone central office, cable system head-end or distribution hub, satellite up-link, broadcast studio, server complex, or data center premises which are distributed throughout and coupled to the network 101. Any configuration that permits the monitoring of data traffic over the network 101 may be used without departing from the spirit and scope of the present invention.

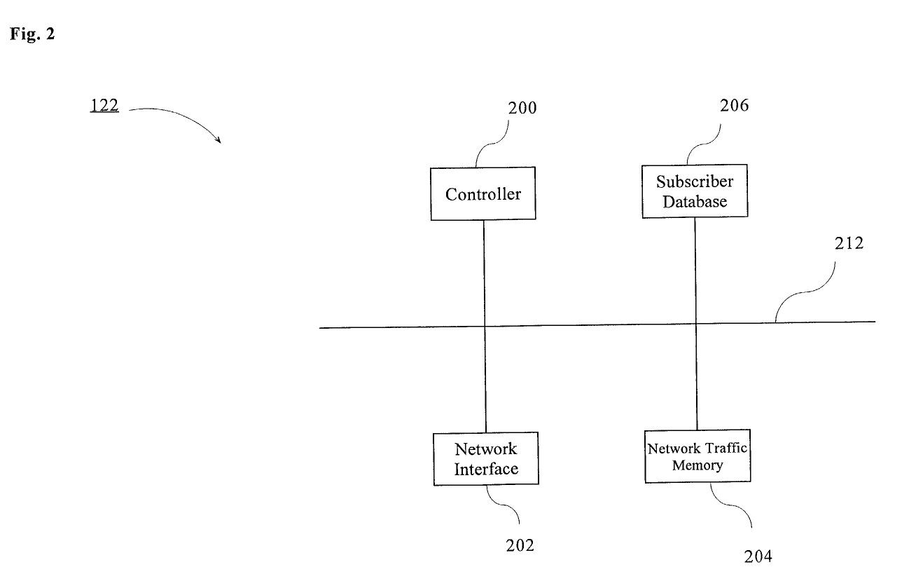

FIG. 2 is an exemplary block diagram of a network monitoring device 122. The network monitoring device 122 includes a controller 200, a network interface 202, a network traffic memory 204 and a subscriber database 206. As shown, the above components can be coupled together through a control/signal bus 212.

In operation, the controller 200 can monitor the communication traffic on the network 101 via network interface 202. The network interface can be coupled to the network 101 or numerous nodes (not shown) of the network via the network 101 itself or a separate network, such as a control network. For example, the controller 200 can monitor the communications of individual terminals 102-108 to and from various websites offered by the servers 112-118. As described above, data concerning the communications of a particular terminal 102-108 can be collected from a header portion of the communication that is used to direct a communication from an originating terminal to a destination terminal.

After monitoring a communication, the controller 200 can further collect and store any network data traffic in the network traffic memory 204. At this point, the network traffic data can be stored in a sorted manner in order to group network traffic directed to particular servers, 112-118, websites, or types of websites together. Furthermore, data traffic originating from a particular terminal 102-108 or group of terminals 102-108 can be grouped together in the network traffic memory 204. Alternatively, the network traffic data can be stored without any organization to be sorted at a later time.

One example of operation could be to use the network monitoring device 122 in order to assist subscribers in real-time traffic-based business planning. For example, a subscriber may request that a network service provider monitor the servers or web sites of certain businesses in a particular category, such as businesses related to the sales of flowers. For the purpose of this example, assume that servers 112-118 all operate websites related to the sales of flowers over the network 101. Furthermore, assume that on this particular day, the server 112 is selling roses at one-half (½) of the price that servers 114-118 are selling the same type of roses. Finally, assume that servers 116 and 118 subscribe to a service of the network monitoring device 122 that provides servers 116 and 118 with network traffic information of the servers in the flower business (i.e., servers 112-118).

Assume that over the course of the same business day, the network monitoring device 122 observes that, of the servers 112-118, server 112 is receiving a large volume of data traffic relative to that of servers 114-118. In response, the network monitoring device 122 can notify the subscribers, servers 116 and 118, of the increased or disproportionate traffic flows. Based on the information, the operators of servers 116 and 118 may be inclined to investigate the server 112's website to see why the server 112 has such a high traffic flow.

From the investigation, the servers 116 and 118 may determine that the server 112 is offering roses at half price, and that is why the server 112 is experiencing high traffic flow. In response, the servers 116-118 may also offer roses at half price in order to compete with server 112. Accordingly, once the information has been disseminated, servers 116 and 118 should experience increased traffic flow.

Because the server 114 will not be notified of the increased volume in traffic, server 114 may remain unaware that servers 112, 116 and 118 have now lowered their price of roses by one half. Accordingly, server 114's marketshare may decrease even more as a result of server 114's limited knowledge of the network market environment.

It is to be understood that not only servers 112-118 can subscribe to the data traffic monitoring service. For example, the users of the terminals 102-108 may wish to subscribe to a service that monitors the traffic flows of certain categories of business or web sites. In the above example, if terminal 102 had subscribed to the traffic flow data of the servers 112-118 that were in the business of selling flowers, the user of terminal 112 would have been notified of the disproportionate traffic flow to server 112 and therefore could have further investigated and possibly benefited from the sale price of roses.

While, in the above examples, the users of the terminals 102-108 and servers 112-118 are described as having to monitor the traffic flow data and decide whether to further investigate and determine the cause of traffic data, it is to be understood that this function may be automated, for example by various software applications, without departing from the spirit and scope of the present invention. Further, the decision of whether or not to change one's presence on the network, such as the lowering of prices in the above example, may also be automated in a like manner without departing from the spirit and scope of the present invention.

In another example, the traffic flow data can be used for the strategic placement of advertisements on web sites in order to maximize the click-through rates or viewing of the advertisements. For example, an advertisement brokerage company that is responsible for the placement of advertising clients' advertisements on web sites or the like for numerous advertising clients can subscribe to the network traffic service in order to receive traffic flow information over the entire network 101. The advertisements may be such that they may be interchangeably displayed on various web sites.

In operation, the advertisement brokerage company can selectively display the advertisement of their clients on web sites that are experiencing a heavy volume of data traffic. For example, while a site is dormant (i.e., receiving less than five visitors per hour), the advertisement brokerage company may choose not to display any advertisements, since very few people will view the advertisements. Further, it may not be cost-effective to rent space on the web site if very few people are to view the advertisement. However, if the advertisement brokerage company receives data traffic from the network monitoring device 122 that a site has a very heavy traffic flow (i.e., 100+ visitors per hour), then the advertisement brokerage company may decide to display their advertising clients' advertisements on the web site.

For example, the increase in traffic flow through the site may be due to a special event being held at the site, such as a broadcast of a sporting event. In any event, the network monitoring device 122 will recognize the increased traffic flow and the subscribing advertisement brokerage company will be able to maximize the viewability of their advertising clients' advertisements by targeting this site during the increased traffic flow. Subsequently, once the network monitoring device 122 determines that the traffic flow to the particular web site has once again decreased, the advertisement brokerage company can once again decide not to display their advertising clients' advertisements at the web sites. Accordingly, the network traffic data can be used to take advantage of the often wildly fluctuating and temporal nature of traffic on the network.

In another example, the network monitoring device 122 can be used to accomplish real-time traffic-based targeting, where advertising is directed at specific sites when traffic is determined to be heavy at that site. For example, if a temporary increase in traffic is monitored at a site that is related to politics, then the network monitoring device 122 can report to an advertisement brokerage company, for example, that there is an increase in traffic to the site that generally relates to politics. Based on this information, the advertisement brokerage company can direct advertisements to this site, and the advertisements can be related to the content of the site, in this case, for example, political ads.

Further, in the above example, the network monitoring device may determine that the data traffic is from the same geological area, such as a state or county. Based on this information, the advertisement brokerage company may further focus the display of advertisements particularly to local clients, such as a store that is mainly located within the identified county or state.

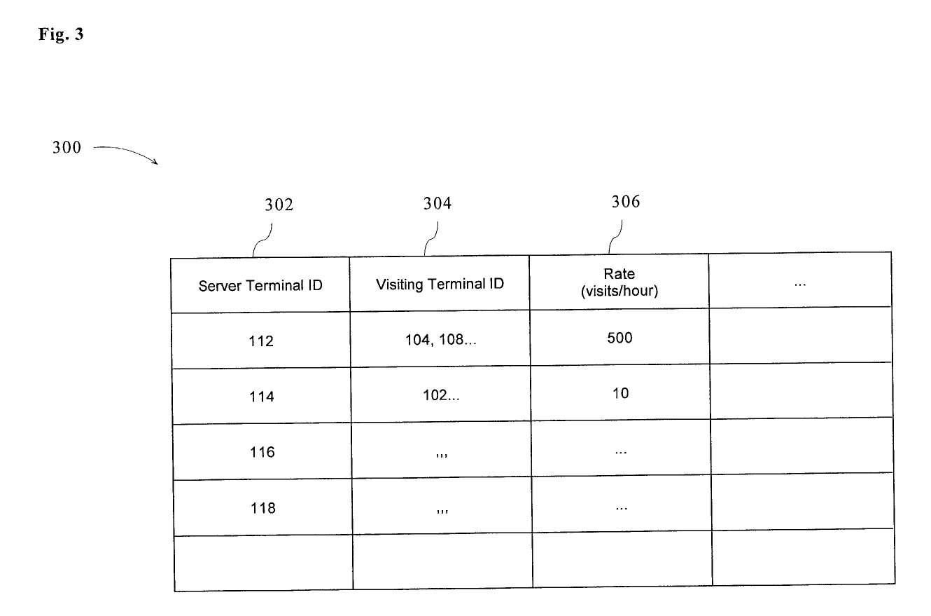

FIG. 3 is an exemplary data structure 300 of the network memory 204 that stores information related to communications on the network 101. Field 302 contains server terminal IDs. For the purposes of this disclosure, the terminal IDs correspond to the reference numerals shown in FIG. 1. For example, the server terminal ID 112 corresponds to server 112.

Field 304 contains the corresponding terminal IDs of the visiting terminals. For example, these can be terminals that are currently connected with the server via the network 101. As described above, this data can be derived from a header portion of a communication traveling across the network. For the purposes of this disclosure, the visiting terminal IDs correspond to the reference numerals shown in FIG. 1.

Field 306 contains a current rate at which the corresponding server identified in field 302 is receiving visitors. The rate may be calculated based on a number of visitors connecting with the server over a predetermined period of time. For example, as shown in field 306, the rate is described in terms of visitors per hour.

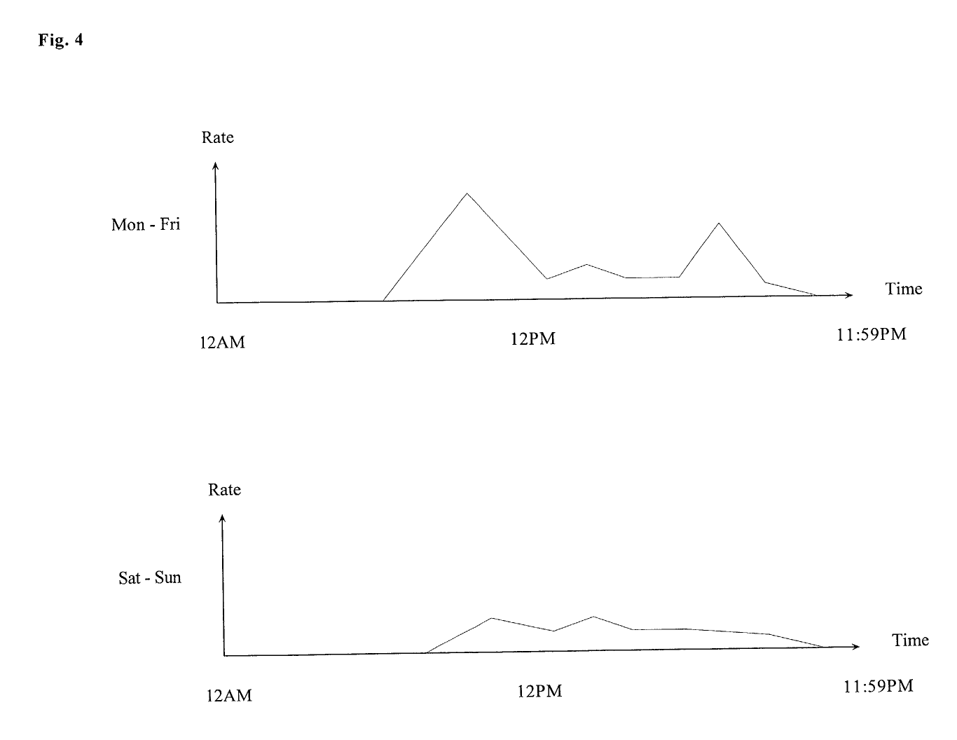

It is to be understood that FIG. 3 is an exemplary data structure of the network traffic memory 204, and that various other fields may be added without departing from the spirit and scope of the present invention. For example, referring to FIG. 4, the network traffic history of a particular server or terminal may be stored over a period of time. For example, a data traffic pattern over a 24-hour period may be stored and analyzed to determine when the site historically receives more or less traffic. Additionally, the 24-hour periods or days may be stored so that traffic patterns over a week or month can be analyzed or determined.

As shown in FIG. 4, it can be seen from the graph that on weekdays, the server corresponding to server terminal ID 112 generally receives its heaviest data traffic flow at 10 a.m. and 7 p.m. Further, as can be seen, on the weekend a server corresponding to server terminal ID 112 receives a generally steady flow of traffic between the period of 8 a.m. and 8 p.m.

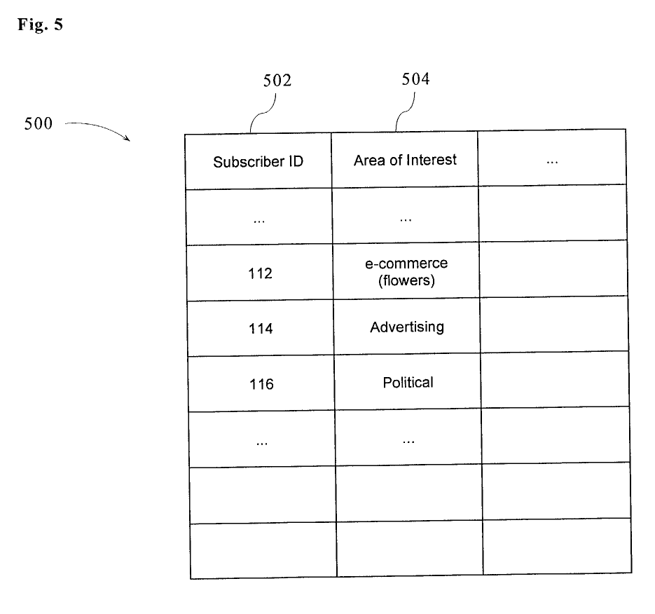

FIG. 5 is an exemplary data structure 500 of the subscriber database 206. Field 502 contains a subscriber ID. This subscriber ID can be the IP address of each of the servers 112-118. For example, the subscriber ID 112 corresponds to the server 112, as shown in FIG. 1.

Field 504 contains a service type ID. The service type ID can identify the area of traffic flow interest in which the corresponding subscriber in field 502 is interested. For example, subscriber 112 is interested in receiving traffic flow data related to e-commerce. More particularly, subscriber 112 is interested in receiving data flow traffic pertaining to e-commerce relating to flowers.

As shown in field 504, the subscriber 114 is interested in receiving data flow traffic so that the server 114 may place ads that are directed at an individual visiting server 114's site. For example, if the controller 200 determines that terminal 102-108 with users having a particularly specialized interest, such as travel, are visiting server 114's website, then server 114 will display advertisements related to travel. Alternatively, if the data traffic or an individual of the data traffic is viewing terminal 114's website, and it has been determined that the visiting terminals have an interest in sporting goods, then the server 114 can display advertisements directed toward the sporting goods, or sporting stores or the like.

In operation, the controller 200 monitors the network 101 via network interface 202. For example, assume that terminal 102 initiates a communication with server 112 via network 101. As the communication travels across the network 101 via a plurality of routers (not shown), the network monitoring device 122 can receive information on the communication. For example, the network monitoring device can extract the address of the terminal 102, the address of the server 112 and a time that the communication was placed from a header portion of the communication.

Once the network monitoring device 122 has received the information, the information may then be stored in the network traffic memory 204. As numerous communications are placed on the network 101, the network monitoring device 122 may continually monitor and collect data on the communications.

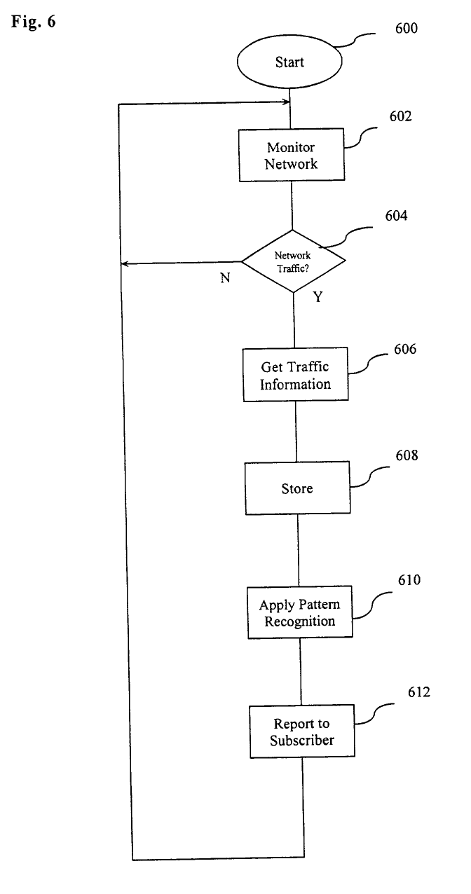

FIG. 6 is a flowchart outlining the exemplary process for monitoring data traffic on a network. In step 600, the process begins. In step 602 the network is monitored for any communications that may be travelling on or across the network. The process then proceeds to step 604.

In step 604 a determination is made as to whether network traffic is traveling on or across the network. If a data communication is detected on the network, then the process proceeds to step 606; otherwise, the process returns to step 602 where the network is continued to be monitored.

In step 606, information contained in the traffic travelling on the network is gathered. The information may include an originating address, a destination address, and a time of transmission for the communication. Furthermore, the information may be extracted from a header portion, such as an IP header portion, of a data communication travelling across the network. The process then proceeds to step 608.

In step 608, the traffic information can be stored in a memory. In step 610 a pattern recognition algorithm can be applied to the stored memory. The pattern recognition may organize the data traffic in any number of ways in order to recognize data traffic flows across the network. For example, the data traffic may be organized by destination terminal. In other words, all data traffic being sent to a particular terminal may be grouped together as a traffic flow. The process then proceeds to step 612.

In step 612, any traffic flow patterns that are recognized in step 610 can be reported to the subscribers. The subscriber may only receive information regarding patterns which are relevant to the subscriber. Control then returns to step 602 where the process can begin again.

As shown in FIG. 2, the method of this invention is preferably implemented on a programmed processor. However, the network monitoring device 122 can also be implemented as part of a switch or a stand-alone or a general purpose or a special purpose computer, a programmed microprocessor or microcontroller and peripheral integrated circuit elements, an Application Specific Integrated Circuit (ASIC), or other integrated, hardware electronic or logic circuit such as a discrete element circuit, a programmable logic device such as a PLD, PLA, FPGA, or PAL, or the like. In general, any device on which exists a finite state machine capable of implementing the flowcharts shown in FIG. 6 can be used to implement the network monitoring device 122 functions of this invention.

While this invention has been described in conjunction with the specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

What is claimed is:

1. A method for providing data traffic status of a network, comprising:
monitoring data traffic over the network, wherein the data traffic includes at least one of data and voice traffic;
determining a traffic level of at least one site of the network; and
selectively displaying traffic information based on the traffic level.

2. The method according to claim 1, wherein determining the traffic level further includes comparing the data traffic of a plurality of sites to determine a relative traffic volume.

3. The method according to claim 2, wherein the plurality of sites share a common attribute.

4. The method according to claim 3, wherein the common attribute is at least one of selling similar products, providing similar types of service and providing similar types of information.

5. The method according to claim 1, wherein determining the traffic level further includes comparing current data traffic for the at least one site to a historical data traffic record.

6. The method according to claim 5, wherein the historical data traffic record is data traffic to the at least one site for a preceding period of time.

7. The method according to claim 1, wherein monitoring the data traffic over the network further includes obtaining an originating address and a destination address for the traffic over the network.

8. The method according to claim 7, wherein the originating address and destination address are obtained from a portion of the data traffic traveling over the network.

9. The method according to claim 1, wherein the traffic information includes at least an address of the at least one site.

10. The method according to claim 9, wherein the traffic information further includes a rate of the data traffic of the at least one site.

11. A method for notifying a subscriber of traffic flow to one or more sites on a network, comprising:
monitoring data traffic to the one or more sites over the network, wherein the data traffic includes at least one of data and voice traffic;
generating a traffic notification when an amount of data traffic to at least one or more of the sites on the network meets at least one predetermined threshold; and
transmitting the traffic notification to the subscriber.

12. The method according to claim 11, wherein determining the traffic level further includes comparing the data traffic of a plurality of sites to determine a relative traffic volume.

13. The method according to claim 12, wherein the plurality of sites are generally related to each other.

14. The method according to claim 13, wherein the plurality of sites share a common attribute.

15. The method according to claim 14, wherein the common attribute is at least one of selling similar products, providing similar types of service and providing similar types of information.

16. The method according to claim 11, wherein monitoring the traffic level further includes comparing current data traffic for the at least one site to a historical data traffic record.

17. The method according to claim 16, wherein the historical data traffic record is data traffic to the at least one site for a preceding period of time.

18. The method according to claim 11, wherein monitoring the data traffic over the network further includes obtaining an originating address and a destination address for the traffic over the network.

19. The method according to claim 18, wherein the originating address and destination address are obtained from a portion of the data traffic traveling over the network.

20. The method according to claim 11, wherein the traffic information includes at least an address of the at least one site.

21. The method according to claim 20, wherein the traffic information further includes a rate of the data traffic of the at least one site.

22. A device that provides data traffic status of a network, comprising:
a network interface;
a subscriber database that stores information related to subscribers; and
a controller, coupled to the network interface and the subscriber database, that monitors data traffic over the network, determines a traffic level of at least one site of the network and selectively displays traffic information to at least one subscriber based on the traffic level, wherein the data traffic includes at least one of data and voice traffic.

23. The device according to claim 22, wherein determining the traffic level further includes comparing the data traffic of a plurality of sites to determine a relative traffic volume.

24. The device according to claim 23, wherein the plurality of sites share a common attribute.

25. The device according to claim 24, wherein the common attribute is at least one of selling similar products, providing similar types of service and providing similar types of information.

26. The device according to claim 22, further comprising a network traffic memory coupled to the controller, wherein determining the traffic level further includes comparing current data traffic for the at least one site to a historical data traffic record stored in the network traffic memory.

27. The device according to claim 26, wherein the historical data traffic record is traffic to the at least one site for a preceding period of time.

28. The device according to claim 22, wherein monitoring the data traffic over the network further includes obtaining an originating address and a destination address for the traffic over the network.

29. The device according to claim 28, wherein the originating address and destination address are obtained from a portion of the data traffic traveling over the network.

30. The method according to claim 22, wherein the traffic information includes at least an address of at least one site.

31. The device according to claim 30, wherein the traffic information further includes a rate of the data traffic of the at least one site.
